(19) United States
(12) Patent Application Publication
(10) Pub. No.: US 2017/0268747 A1
(43) Pub. Date: Sep. 21, 2017

(54) LED Optic for Offset Beam Generation

(71) Applicant: Ronald G. Holder, Laguna Niguel, CA (US)

(72) Inventor: Ronald G. Holder, Laguna Niguel, CA (US)

(21) Appl. No.: 14/925,832

(22) Filed: Oct. 28, 2015

Related U.S. Application Data
(60) Provisional application No. 62/072,236, filed on Oct. 29, 2014.

(51) Int. Cl. F21V 13/04; F21V 17/10; F21V 5/04; F21V 7/00; F21V 19/00; F21V 5/08

(52) U.S. Cl. CPC F21V 13/04; F21V 19/0035; F21V 5/08; F21V 5/04; F21V 7/0033; F21V 7/0066; F21V 17/102; F21Y 2101/02

(57) ABSTRACT

A light emitting diode can produce light in a lighting system. The lighting system can bias the light relative to an optical axis of the light emitting diode. The light emitting diode can be positioned at the rear or back of a cavity formed between four reflective surfaces. A lens can extend across the cavity, between two of the reflective surfaces that face one another. The lens can be elongate in form, for example.

### CROSS REFERENCE TO RELATED APPLICATIONS

This application claims priority to U.S. Provisional Patent Application No. 62/072,236 filed Oct. 29, 2014 in the name of Ronald Garrison Holder and entitled “An LED Optic for Offset Beam Generation,” the entire contents of which are hereby incorporated herein by reference.

### TECHNICAL FIELD

Embodiments of the disclosure relate generally to systems for generating illumination using light emitting diodes or other light sources, and more particularly to lighting systems that utilize a combination of reflective and refractive surfaces to produce an illumination pattern.

### BACKGROUND

For illumination applications, light emitting diodes (LEDs) offer substantial potential benefit associated with their energy efficiency, light quality, and compact size. However, to realize the full potential benefits offered by light emitting diodes, new technologies are needed. For instance, relative to incandescent lights, light emitting diodes typically have different light emission patterns.

Accordingly, there are needs in the art for technology to manage illumination produced by one or more light emitting diodes. For example, need exists for technology to direct light off axis or create offset illumination patterns. A capability addressing one or more such needs, or some other related deficiency in the art, would support improved illumination systems and more widespread utilization of light emitting diodes in lighting applications.

### SUMMARY

In one aspect of the disclosure, a lighting system or luminaire can comprise a light emitting diode disposed at a rear of a cavity. The cavity can be formed by four reflective surfaces. A lens can extend across the cavity, between two of the reflective surfaces. A portion of the light emitted by the light emitting diode can exit the cavity without incidence on any of the reflective surfaces or the lens. Another portion of the light emitted by the light emitting diode can be incident on the lens. Another portion of the light emitted by the light emitting diode can be incident on one or more of the reflective surfaces.

The foregoing discussion of certain aspects of the disclosure is for illustrative purposes only. Various aspects of the technology may be more clearly understood and appreciated from a review of the following text and by reference to the associated drawings and the claims that follow. Other aspects, systems, methods, features, advantages, and objects of the present technology will become apparent to one with skill in the art upon examination of the following drawings and text. It is intended that all such aspects, systems, methods, features, advantages, and objects are to be included within this description and covered by this application and by the appended claims of the application.

### BRIEF DESCRIPTION OF THE FIGURES

Reference will be made below to the accompanying drawings.

FIG. 1 illustrates a perspective view of an optical system comprising a light emitting diode and an optic according to some example embodiments of the disclosure.

FIG. 2 illustrates a front view of the optical system according to some example embodiments of the disclosure.

FIG. 3 illustrates a cross sectional view of the optical system according to some example embodiments of the disclosure.

FIG. 4 illustrates a side view of the optical system according to some example embodiments of the disclosure.

FIG. 5 illustrates another cross sectional view of the optical system according to some example embodiments of the disclosure.

FIG. 6 illustrates a plan view of the optical system according to some example embodiments of the disclosure.

FIGS. 7A and 7B illustrate representative rays of the optical system illuminating a surface according to some example embodiments of the disclosure.

The drawings illustrate only example embodiments and are therefore not to be considered limiting of the embodiments described, as other equally effective embodiments are within the scope and spirit of this disclosure. The elements and features shown in the drawings are not necessarily drawn to scale, emphasis instead being placed upon clearly illustrating principles of the embodiments. Additionally, certain dimensions or positionings may be exaggerated to help visually convey certain principles. In the drawings, similar reference numerals among different figures designate like or corresponding, but not necessarily identical, elements.

### DESCRIPTION OF EXAMPLE EMBODIMENTS

An optical system can direct light emitted by one or more light emitting diodes (LEDs) to form a distribution of illumination that is offset or biased relative to an axis of the one or more light emitting diodes. Examples of the resulting illumination pattern may include one or more offset profile beams, one or more non-radially symmetric beams, and/or one or more non-multi-axis symmetric beams. A device incorporating the technology can be useful across the field of general illumination and lighting or in a specific niche thereof. Representative applications can include street and area lighting, wall wash lighting, signage lighting, and various other lighting applications, for example applications benefitting from an offset smooth beam. The optical system can be incorporated in streetlights, wall wash fixtures, luminaires, and other appropriate applications, for example.

In some example embodiments, one or more light emitting diodes emit light into at least three solid angles. The optical system can comprise an optic that is positioned to manage the emitted light in each of these solid angles. The optic can comprise an open area, a lens, and at least one reflector. The open area can be disposed to pass the light emitted into the first solid angle, resulting in a direct beam. The lens can be positioned to refract the light emitted into the second solid angle, resulting in a refracted beam. The at least one reflector can be oriented to reflect the light emitted into the third solid angle, resulting in a reflected beam. The direct beam, the refracted beam, and the reflected beam can form a distribution of illumination that may be offset or biased relative to an axis of the one or more light emitting diodes.

The term “beam,” as used herein, is intended to be sufficiently broad to describe a collective light output (or a portion of an output) of a device, without being limited to a focused, collimated, or otherwise narrow beam of light.

Some representative embodiments will be described more fully hereinafter with example reference to the accompanying drawings that illustrate embodiments of the technology. The technology may, however, be embodied in many different forms and should not be construed as limited to the embodiments set forth herein; rather, these embodiments are provided so that this disclosure will be thorough and complete, and will fully convey the scope of the technology to those appropriately skilled in the art.

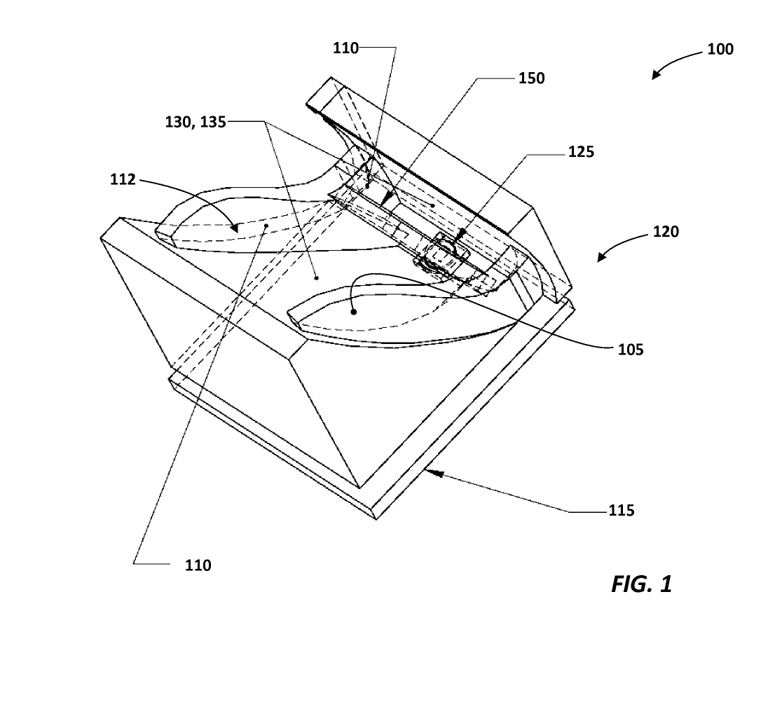

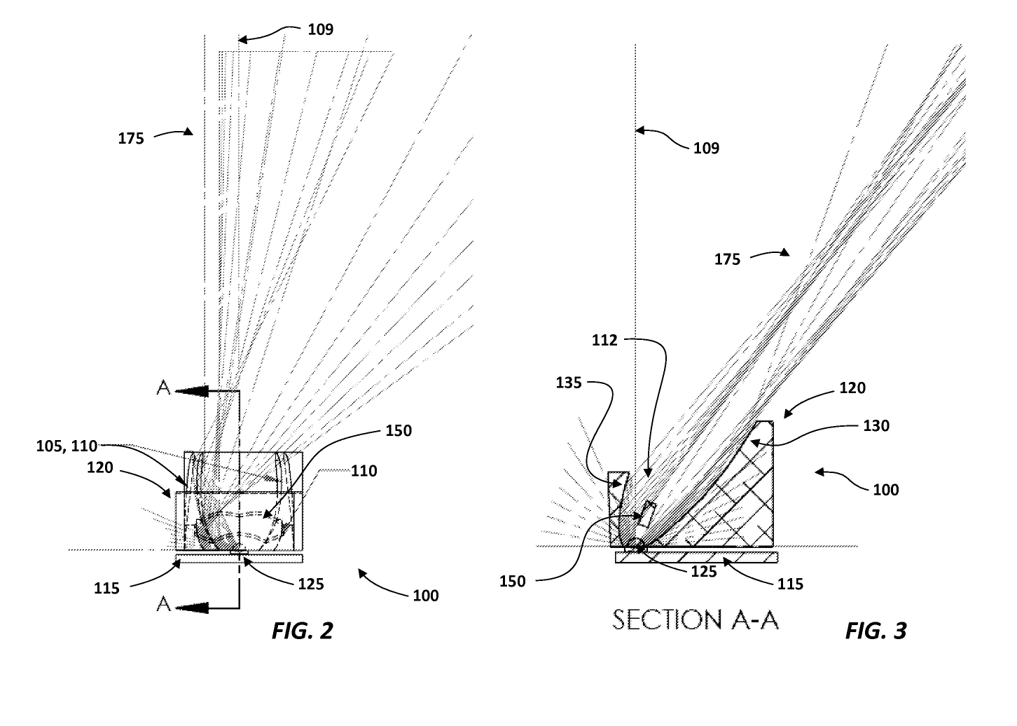

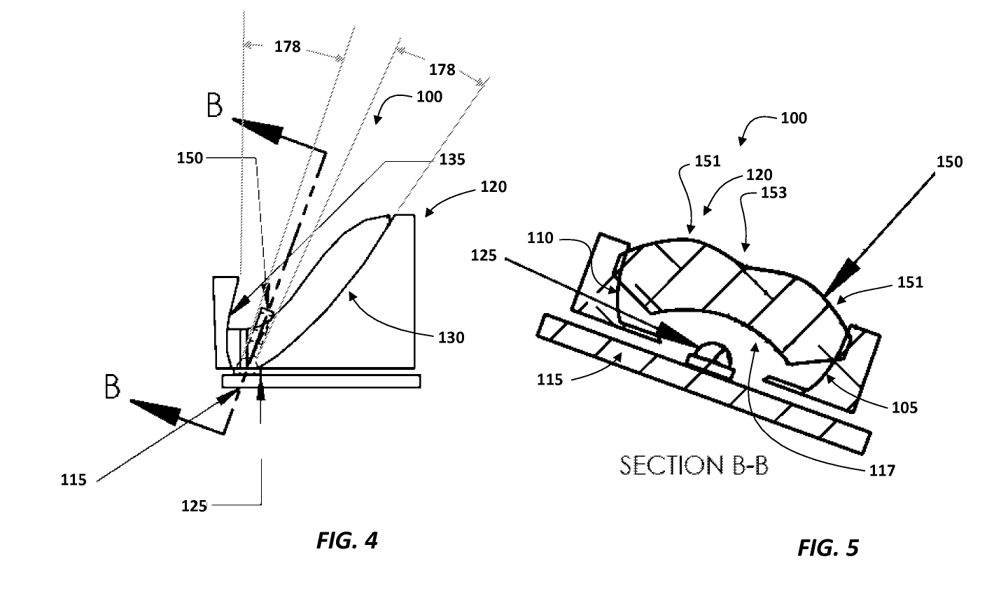

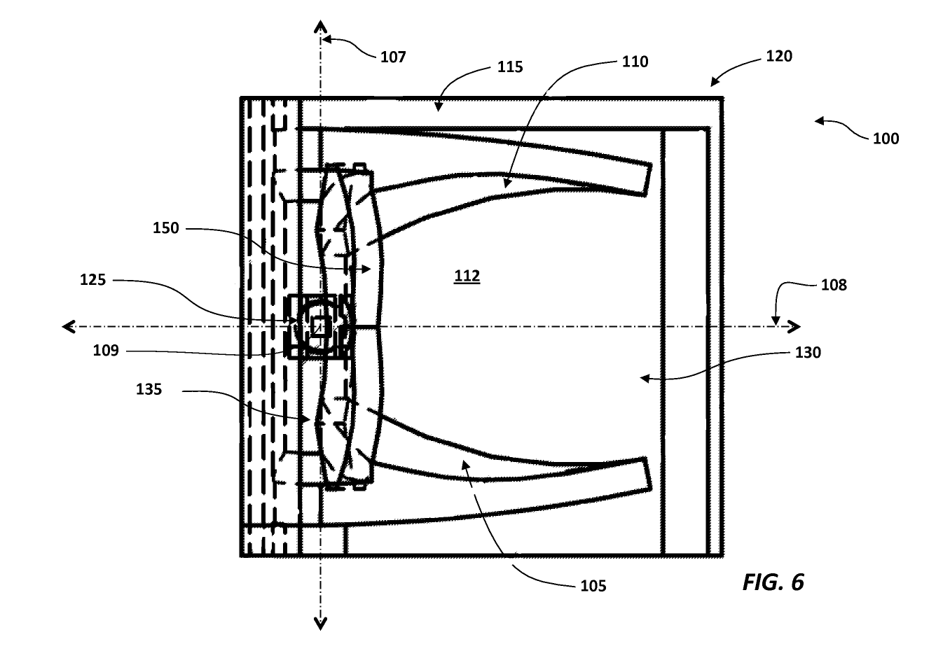

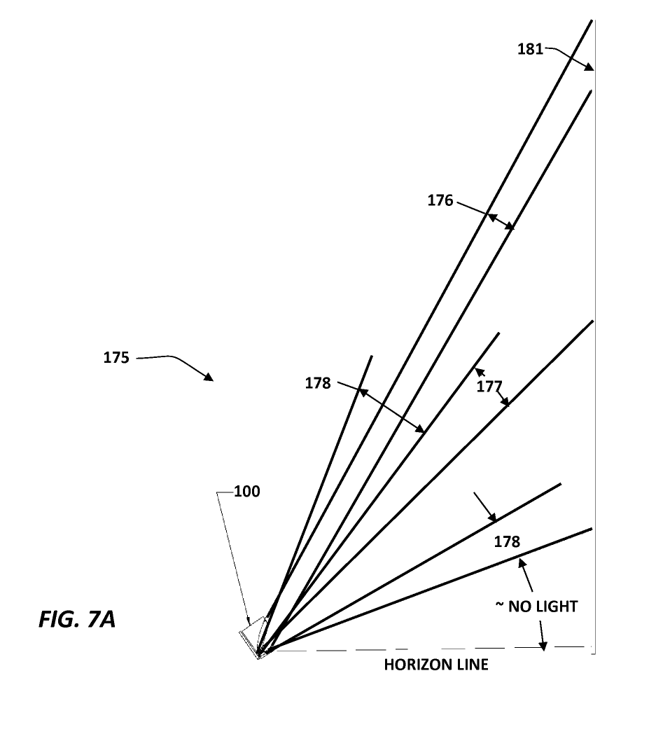

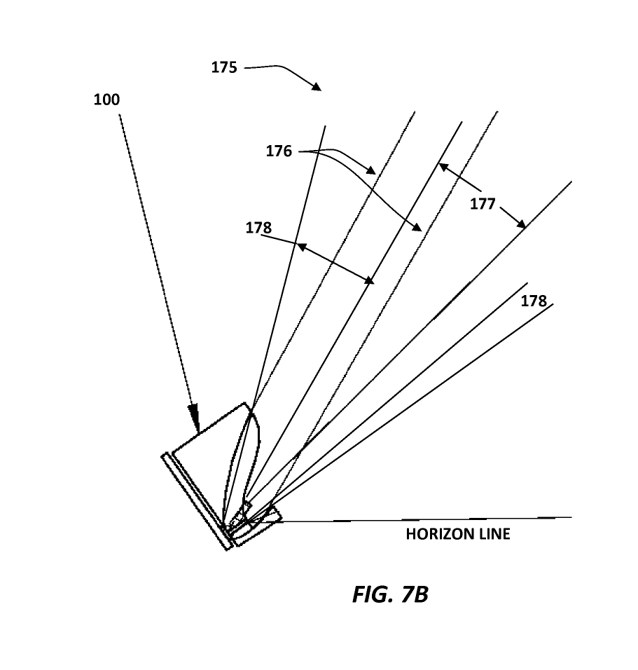

Turning now to the drawings, FIGS. 1-7 illustrate views and details of an example embodiment of an optical system 100 that will be described in further detail below. FIG. 1 illustrates a perspective view of the optical system 100 comprising a light emitting diode 125 and an optic 120 according to some example embodiments of the disclosure. FIG. 2 illustrates a front view of the optical system 100 according to some example embodiments of the disclosure. FIG. 3 illustrates a cross sectional view of the optical system 100, with the cross section taken along the line A-A depicted in FIG. 2 according to some example embodiments of the disclosure. FIG. 4 illustrates a side view of the optical system 100 according to some example embodiments of the disclosure. FIG. 5 illustrates a cross sectional view of the optical system 100, with the cross section taken along the line B-B depicted in FIG. 4 according to some example embodiments of the disclosure. FIG. 6 illustrates a plan view of the optical system 100 according to some example embodiments of the disclosure. FIGS. 7A and 7B (collectively FIG. 7) illustrate representative rays of the optical system 100 illuminating a surface 181 according to some example embodiments of the disclosure. FIG. 7A provides an overall view, and FIG. 7B provides a magnified view in the area of the optical system 100.

The illustrated embodiment will now be described in further detail with general reference to all the figures.

In the example optical system 100 illustrated in FIGS. 1, 2, 3, 4, 5, 6, and 7, the light emitting diode 125 is mounted to a circuit board 115, specifically a printed circuit board (PCB), with an accompanying optic 120. The optic 120 comprises a lens 150, a side reflector 105, another side reflector 110, a front reflector 130, and a rear reflector 135.

The side reflectors 105, 110, the front reflector 130, and the rear reflector 135 form a cavity 112 in which the lens 150 is mounted. The cavity 112 is tapered in that the cavity 112 has a cross section that generally decreases in area towards the cavity rear. The light emitting diode 125 is located at the rear of the cavity 112 and emits light into the cavity 112. The emitted light illuminates and is incident upon the side reflectors 105, 110, the front reflector 130, the rear reflector 135, and the lens 150. Each of the side reflectors 105, 110, the front reflector 130, and the rear reflector 135 reflects incident light. The lens 150 refracts incident light.

In the illustrated embodiment, the side reflectors 105, 110 are concave and are disposed on opposing sides of an optical axis 109 of the light emitting diode 125. As illustrated, the front and rear reflectors 130, 150 are also concave and disposed on opposing sides of the optical axis 109.

In support of describing some example embodiments, it can be useful to characterize the optical axis 109 as an intersection between two perpendicular reference planes 107, 108 as shown in FIG. 6 (where the reference planes 107, 108 are perpendicular to the page and thus appear as lines).

With this reference framework, the side reflectors 105, 110 are intersected by the reference plane 107 and are symmetric with respect to the reference plane 108. The side reflectors 105, 110 further extend along opposing sides of the reference plane 108. Additionally, the reference plane 108 intersects the front and rear reflectors 130, 150. The front and rear reflectors 130, 150 are asymmetric with respect to the reference plane 107.

In the illustrated embodiment, the lens 150 is symmetrical with respect to the reference plane 108. The lens 150 is further offset from the optical axis 109 of the light emitting diode 125. As illustrated, the lens 150 is disposed substantially on the side of the reference plane 107 that faces the front reflector 130.

In form, the lens 150 is elongate and extends from the side reflector 105 to the side reflector 110. The side reflectors 105, 110 further support the ends of the lens 150, and the lens 150 extends in a suspended manner over of above the light emitting diode 125. As best seen in FIG. 5, the illustrated embodiment of the lens 150 comprises a concave surface 117 that faces and receives light from the light emitting diode 125. The opposite, outer surface of the lens 150 faces away from the light emitting diode 125, emits light, and comprises two convex surfaces 151. An indentation 153 between the two convex surfaces 151 extends along and is intersected by the reference plane 108.

In an example embodiment, the lens 150 redistributes energy that would be concentrated in the center of a beam if the lens 150 were not utilized. For example, embodiments of the indentation 153 can redistribute incident light.

In various embodiments, the light emitting diode 125 can comprise one or more discrete light emitting diodes, an array or group of light emitting diodes, or a chip-on-board light emitting diode. In some embodiments, the light emitting diode 125 comprises an array that may include similarly colored light emitting diodes, white or otherwise, or optionally various colored light emitting diodes, for example.

In some example embodiments, the reflectors 105, 110, 130, 135 can comprise a molded plastic part that is secondarily coated with a reflective material. In some embodiments, the coating of reflective material can comprise silver, aluminum, or other appropriate metal or material, for example.

The molded plastic part may be seamless or have a unitary construction. Alternatively, the reflectors 105, 110, 130, 135 can be fabricated as individual components that are glued, welded, fused, or otherwise jointed together. Whether formed as a unitary element or fabricated by joining multiple elements, the reflectors 105, 110, 130, 125 and the lens 150 can meet one another in respective corners. For example, the optic 120 can comprise a corner formed between the side reflector 105 and the front reflector 130, another corner formed between the side reflector 110 and the front reflector 130, another corner formed between the side reflector 105 and the rear reflector 125, another corner formed between the side reflector 110 and the rear reflector 125, another corner formed between the side reflector 110 and the lens 150, and another corner formed between the side reflector 105 and the lens 150. In an example embodiment, the corners can be radiused to facilitate manufacture or to soften the optical effect of a sharp corner on the beam.

On larger embodiments, the reflector surfaces may be folded and formed from highly reflective sheet metal, for example. Other materials, such as glass can also be utilized. In some example embodiments, the lens 150 can also be molded of an optical plastic material or glass.

A portion of the light emitted by the light emitting diode 125 exits the cavity 112 without contacting the lens 150 or any of the reflectors 105, 110, 130, 135. This emitted light forms a direct beam 178 as illustrated in FIG. 7.

Another portion of the light emitted by the light emitting diode 125 is incident upon and refracted by the lens 150. The resulting light forms a refracted beam 177 as illustrated in FIG. 7.

Another portion of the emitted light is incident upon and is reflected by at least one of the reflectors 105, 110, 130, 135. This emitted light forms a reflected beam 176 as illustrated in FIG. 7.

As best illustrated by FIG. 7, the reflected beam 176, the refracted beam 177, and the direct beam 178 combine to form a light distribution 175 for illuminating a surface 181, such as a wall, screen, street, or pathway, (or an area or volume) for example. The light distribution 175 is biased or offset relative to the optical axis 109 of the light emitting diode 125. Thus, the optical system 100 can distribute illumination preferentially to one or more areas that may be displaced from immediately in front of the light emitting diode 125.

In an example embodiment, the surfaces of the optic 120 collect light from the light emitting diode 125 and distribute this light into the light distribution 175 utilizing refraction, reflection, and direct light from the light emitting diode 125. The light distribution 175 can comprise a combined beam formed by the reflected light of the reflectors 105, 110, 130, 135, the refracted light of the lens 150 (or other refractors), and direct light from the light emitting diode 125 that is not incident on the reflectors 105, 110, 130, 135 or the lens 150.

In some example embodiments, the optical system 100 produces a smooth offset beam that incorporates multiple beams. A reflected beam 176 can be produced by front and back angled reflector surfaces and four side reflective surfaces. A direct beam 178 can be direct light from the light emitting diode 125. The direct beam 178 can illuminate a surface, such as the wall 181, as illustrated in FIG. 7A, without incidence upon any surfaces of the optic 120. A refracted beam 177 can come from the lens 150. In other words, the lens 150 can produce a refracted beam 177 as illustrated in FIG. 7A. A resulting iso-candela map can be non-uniform about a primary axis of the optical system 100, or about the optical axis 109 of the light emitting diode 125.

In some example embodiments, the optical system 100 incorporates facets, Fresnel type ‘flattening’ of surface shapes, diffusing techniques, or other surface enhancements that may be added to achieve various effects that may be useful for some applications.

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of this application. Although specific terms are employed herein, they are used in a generic and descriptive sense only and not for purposes of limitation.

What is claimed is:

1. A system comprising:
at least one light emitting diode that emits light into a first solid angle, a second solid angle, and a third solid angle; and
an optic positioned to manage the emitted light, the optic comprising:
an open area disposed to pass the light emitted into the first solid angle to create a direct beam;
a lens disposed to refract the light emitted into the second solid angle to create a refracted beam; and
a reflector disposed to reflect the light emitted into the third solid angle to create a reflected beam.

2. The system of claim 1, wherein the first beam, the second beam, and the third beam form a distribution of light that is offset relative to an optical axis of the at least one light emitting diode.

3. The system of claim 1, wherein the first solid angle, the second solid angle, and the third solid angle are contiguous.

4. The system of claim 1, wherein at least two of the first solid angle, the second solid angle, and the third solid angle are noncontiguous.

5. The system of claim 1, wherein the reflector comprises a system of reflectors, the system of reflectors forming a perimeter around the at least one light emitting diode.

6. The system of claim 1, wherein the reflector comprises four curved reflectors.

7. The system of claim 6, wherein the open area is disposed between the four curved reflectors.

8. The system of claim 7, wherein the lens is disposed between the four curved reflectors adjacent the open area.

9. The system of claim 1, wherein the at least one light emitting diode comprises a chip-on-board light emitting diode.

10. The system of claim 1, wherein the reflector is one of a first reflector, a second reflector, a third reflector, and a fourth reflector,
wherein the first reflector is disposed on a first side of the at least one light emitting diode,
wherein the second reflector is disposed on a second side of the at least one light emitting diode, opposite the first reflector,
wherein the third reflector is disposed on a third side of the at least one light emitting diode, between the first reflector and the second reflector,
wherein the fourth reflector is disposed on a fourth side of the at least one light emitting diode, between the first reflector and the second reflector, opposite the third reflector, and
wherein the first reflector, the second reflector, the third reflector, and the fourth reflector form a four-sided cavity in which the at least one light emitting diode, the lens, and the open area are disposed.

11. The system of claim 1, wherein the first reflector, the second reflector, the third reflector, and the fourth reflector are formed from a unitary piece of plastic.

12. The system of claim 1, wherein the at least one light emitting diode comprises an array of light emitting diodes.

13. The system of claim 1, wherein the at least one light emitting diode is mounted on a circuit board, and
wherein the optic is mounted to the circuit board.

14. A lighting system comprising:
a light emitting diode that is disposed at a rear of a cavity and that comprises an optical axis, the optical axis formed by an intersection between a first reference plane and a second reference plane that are perpendicular to one another;
a first pair of reflective surfaces that are disposed on first opposing sides of the optical axis to form a first portion of the cavity, with the first reference plane intersecting the first pair of reflective surfaces;
a second pair of reflective surfaces that are disposed on second opposing sides of the optical axis to form a second portion of the cavity, with the second reference plane intersecting the second pair of reflective surfaces; and
a lens that extends across the cavity, between the first pair of reflective surfaces.

15. The lighting system of claim 14, wherein an optic comprises the first pair of reflective surfaces, the second pair of reflective surfaces, and the lens,
wherein the optic comprises an outline that is square or rectangular,
wherein the lens comprises:
a first refractive surface that faces away from the light emitting diode, that emits light, and that comprises:
a first convex portion;
a second convex portion; and
an indentation that is formed between the first convex portion and the second convex portion and that is disposed adjacent the optical axis;
a second refractive surface that faces towards the light emitting diode, that receives light, that is concave, and that arches in front of the light emitting diode; and
a first end portion that is supported by a first reflective surface in the first pair of reflective surfaces; and
a second end portion that is supported by a second reflective surface in the first pair of reflective surfaces.

16. The lighting system of claim 14, wherein the lens is elongate.

17. The lighting system of claim 14, wherein the lens is disposed is a position that is offset from the optical axis.

18. A lighting system comprising:
a light emitting diode that is disposed at a rear of a cavity and that comprises an optical axis, the optical axis formed by an intersection between a first reference plane and a second reference plane that are perpendicular to one another;
a first reflective surface and a second reflective surface that are concave, that are disposed on opposing sides of the optical axis, that are intersected by the first reference plane, and that are substantially symmetrical with respect to the second reference plane; and
a third reflective surface and a fourth reflective surface that are concave, that are intersected by the second reference plane, that are substantially asymmetrical with respect to the first reference plane, and that extend between the first reflective surface and the second reflective surface,
wherein the first reflective surface, the second reflective surface, the third reflective surface, and the fourth reflective surface form the cavity.

19. The lighting system of claim 18, further comprising an elongate lens that extends from the first reflective surface to the second reflective surface and that is supported by the first reflective surface and the second reflective surface.

20. The lighting system of claim 18, further comprising a lens that is disposed in the cavity offset from the optical axis.
